(19) United States
(12) Patent Application Publication
(10) Pub. No.: US 2015/0324537 A1
(43) Pub. Date: Nov. 12, 2015

(54) METHOD FOR CONTROLLING MEDICAL EXAMINATIONS VIA A PATIENT COMMUNICATION SYSTEM, AND A PATIENT COMMUNICATION SYSTEM, A PATIENT DEVICE AND A CLINIC SERVER UNIT

(71) Applicant: Siemens Aktiengesellschaft, Muenchen (DE)

(72) Inventors: Klaus Mayer, Eckental (DE); Mike Mueller, Moehrendorf (DE); Elmar Seeberger, Weissenburg (DE)

(73) Assignee: SIEMENS AKTIENGESELLSCHAFT, Muenchen (DE)

(21) Appl. No.: 14/706,220

(22) Filed: May 7, 2015

(30) Foreign Application Priority Data
May 7, 2014 (DE) 102014208532.2

(51) Int. Cl. G06F 19/00; G06Q 10/10

(52) U.S. Cl. CPC G06F 19/3418; G06F 19/3406; G06Q 10/1095; G06Q 10/107

(57) ABSTRACT

A method for controlling medical examinations by means of a patient communication system and includes connecting a patient device to a clinic server unit, and exchanging examination information between the patient device and the clinic server unit. The exchange of examination information can include a retrieval of examination information from the clinic server unit by means of the patient device, a retrieval of a calendar entry, and a retrieval of patient information.

### BACKGROUND OF THE INVENTION

1. Field of the Invention

The present invention concerns a method for controlling medical examinations via a patient communication system, as well as a patient communication system, a patient device, a clinic server unit, and a computer-readable storage medium for implementing such a method.

2. Description of the Prior Art

The scheduling and control of medical examinations are tasks that have to be performed in many environments, particularly in the clinical field.

In everyday clinical practice, the scheduling of examinations can represent an extremely complex challenge, particularly when multiple examination subjects must interact with multiple medical imaging devices.

### SUMMARY OF THE INVENTION

An object of the invention is to provide a method that facilitates the scheduling and control of such examinations and allows an exchange of examination information.

A method for controlling medical examinations by means of a patient communication system is provided according to the invention, which includes the steps of connecting a patient device to a clinic server unit, and exchanging examination information between the patient device and the clinic server unit.

A database is a system for managing data electronically, in particular for storing, overwriting and deleting data and for optimizing requests to the database. The database provides a database language for such requests. An input parameter of a database can comprise a specific data record but it can also just comprise a line, column or even just a single entry in a table. Different input parameters can differ in different levels of scalability, being able to be scaled for example in a nominal, ordinal or cardinal manner.

The connecting of the patient device to a clinic server unit allows a data exchange between patient device and clinic server unit and takes place via a network, for example an internet or an intranet, with authentication preferably taking place by way of a user ID and/or a password. The connection can also be established with the use of a framework, for example Active Server Pages .NET (ASP.NET).

Examination information here refers in particular but not exclusively to the following information: examination appointments to which the patient is to be invited, documents a patient should bring to an examination appointment, information about whether for example a patient should fast before an examination appointment, an information sheet for an upcoming examination, directions to an examination site, and a building map of an examination building.

The invention utilizes a data exchange between the patient device and the clinic server unit to facilitate the scheduling and control of medical examinations and to allow an exchange of examination information between a clinic and a user of the patient device, generally a patient.

In a preferred embodiment, the exchange of examination information comprises a retrieval of examination information from the clinic server unit by means of the patient device. A retrieval of examination information here also comprises downloading the examination information. This means that the examination information is directly available on the patient device and in most circumstances does not have to be downloaded again from the clinic server unit. This helps the user and also allows examination information to be looked at in places where there is no network connection. The retrieval of examination information itself can also take place by means of a trigger, for example by means of a push service, in other words an information flow is controlled by the transmitter, in this instance by the clinic server unit.

In another embodiment the exchange of examination information includes a retrieval of a calendar entry. If the examination information also includes an examination appointment, to which the patient is to be invited, it is also ensured, by a preferably automatic retrieval of the associated calendar entry, that the user does not forget the corresponding appointment. The retrieval of the calendar entry preferably also includes the setting of a reminder function on the patient device, so the user can be notified of the examination appointment beforehand.

In a further embodiment the exchange of examination information comprises a retrieval of patient information by means of the patient device. Patient information here refers in particular but not exclusively to the following information: information obtained by a user after an examination appointment has taken place, an explanation of medical terms, details of prescribed and/or administered medication, medical findings, a summary and/or brief description of the medical findings.

This allows the user to be informed specifically about an examination, enabling him/her to access said information in a simple manner after an examination appointment. This allows the user to be extensively informed about an examination, without forgetting information or parts of said information after a conversation that may in some circumstances only be verbal.

In a preferred embodiment, the exchange of examination information comprises the transmission of a postponement request to the clinic server unit by means of the patient device. If an examination appointment to which a patient is to be invited is an appointment the patient cannot keep, the transmission of the postponement request can inform clinic personnel and/or the clinic server unit of the desire for a different appointment. This increases flexibility for the user of the patient device but also facilitates appointment scheduling in a clinic, as changes or change requests can be made directly. The associated time saving also gives rise to a cost saving.

In another embodiment the examination information is retrieved again after the postponement request has been transmitted by means of the patient device. Again retrieval can take place by means of a trigger, for example a push service. Retrieval can also include an automatic appointment search, in other words after receipt of the postponement request the clinic server unit searches automatically for a free appointment for example and submits this as a suggestion. However retrieval can also include a manual appointment search, in other words a free appointment has to be confirmed (in advance) for example, by clinic personnel or a clinic user interface. This allows the search for a new appointment to be carried out in a manner that saves time and resources.

In a further embodiment, the new retrieval of the examination information comprises a new retrieval of a calendar entry. A user's calendar can thus be kept updated in respect of an examination appointment. Retrieval of the calendar entry can also include, for example, an updating of the existing calendar entry. Retrieval of the calendar entry also preferably includes the setting of a reminder function on the patient device, so that the user can be notified of the examination appointment beforehand.

In another preferred embodiment the exchange of examination information takes place automatically and/or by a trigger. An automatic exchange ensures that any changes are updated, for example at predetermined time intervals; an exchange by means of a trigger, for example a push service, ensures continuous updating of any changes. Both serve to enhance user friendliness.

In another embodiment, the exchange of examination information comprises a transmission of an examination request. The autonomous transmission of an examination request for example allows a user to register for an examination him/herself or make an appointment request. It is, however, possible for this to be done for examinations other than those, the costs of which are not reimbursed by a medical insurance scheme, thereby increasing flexibility.

In a further embodiment, after the examination request has been transmitted the examination information is retrieved again by means of the patient device. The new retrieval keeps the examination information completely up to date. Retrieval can also comprise an automatic appointment search, in other words after receipt of the new examination request the clinic server unit automatically searches for a free appointment for example and submits this as a suggestion. Retrieval can however also comprise a manual appointment search, in other words a free appointment has to be confirmed beforehand for example by clinic personnel or a clinic user interface. This allows the search for a new appointment to be carried out in a manner that saves time and resources. Retrieval itself can again take place automatically and/or by means of a trigger, for example a push service.

In a preferred embodiment, the exchange of examination information comprises a transmission of query information to the clinic server unit via the patient device. Query information here refers, for example, to contact information such as a telephone number, at which a user can be contacted for any queries or at which some other message can be left for the user. This message can also be displayed on the patient device. This improves the information flow between user and clinic personnel and facilitates contact.

The present invention also encompasses a patient communication system for controlling medical examinations, and a patient device for connecting to a clinic server unit, and a clinic server unit for managing communication data is also provided.

The patient communication system, the patient device and the clinic server unit each include a processor and a storage unit that are designed to perform the method steps described in detail above.

The present invention also encompasses a non-transitory, computer-readable data storage medium encoded with programming instructions, which can be loaded into a memory of a programmable controller or computer of a patient communication system and/or of a patient device and/or of a clinic server unit. The instructions cause the processor or computer to execute all or some of the embodiments of the inventive method described above, when the instructions run in the controller or control facility of the patient communication system and/or of the patient device and/or of the clinic server unit. The instructions may require program means, for example libraries and auxiliary functions, to implement the corresponding embodiments of the method. The programming instructions here can be in source code, which still has to be compiled and linked, or which only has to be interpreted, or in an executable software code, which only has to be loaded into the corresponding computation unit for execution.

The computer-readable storage medium can be, e.g. a DVD, a magnetic tape or a USB stick, on which electronically readable control information, in particular software, is stored.

The advantages of the inventive patient communication system, the inventive patient device, the inventive clinic server unit, and the inventive computer-readable storage medium correspond essentially to the advantages of the inventive method, which described in detail above. Features, advantages or alternative advantages mentioned above can also be related to the other aspects of the invention, and vice versa. The corresponding functional features of the method here are configured by corresponding objective modules, in particular by hardware modules.

### BRIEF DESCRIPTION OF THE DRAWINGS

FIG. 1 shows an inventive patient communication system.

FIG. 2 is a flowchart of the embodiment of the inventive method.

### DESCRIPTION OF THE PREFERRED EMBODIMENTS

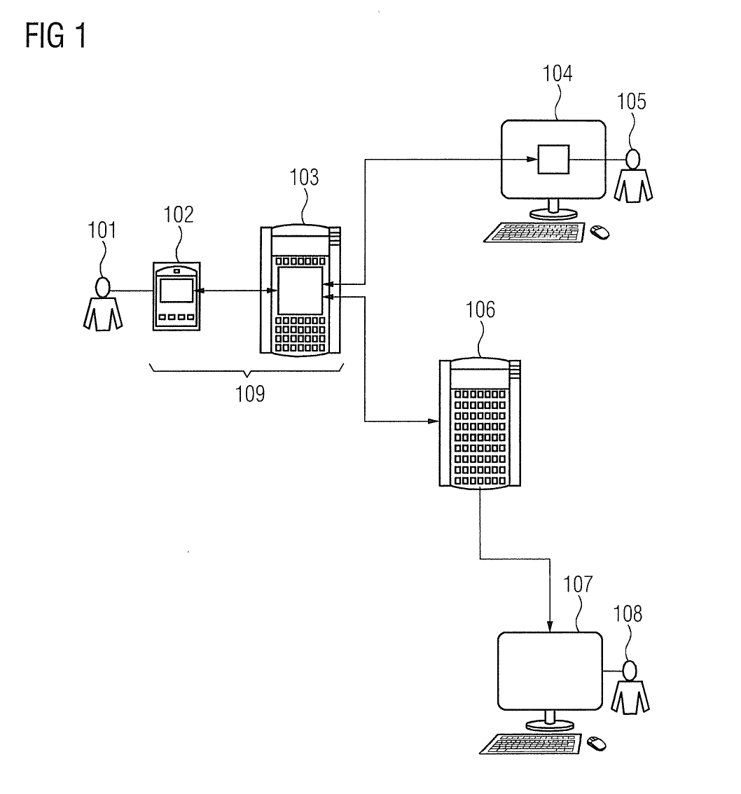

FIG. 1 shows an inventive patient communication system 109. The patient communication system 109 comprises a patient device 102 for connecting to a clinic server unit 103 and the clinic server unit 103 for managing communication data.

A user 101, generally a patient, of the patient device 102 can now initiate a data exchange between the patient device 102 and the clinic server unit 103, by for example retrieving examination information from the clinic server unit 103 by means of the patient device 102, transmitting a postponement request for an examination appointment or even commissioning an examination request him/herself.

A possible sequence for the scheduling of an examination appointment is as follows:
entry of an input that designates appointment via an input screen of a user interface at a workstation 104 by clinic personnel 105 at reception,
booking of the appointment via the clinic server unit 103,
initiation of an optional notification by a web service by way of the user interface,
selection and/or entry of further optional information for the user 101, and
forwarding of the appointment and the optional additional information by the web service to the patient device 102.

A possible sequence for rescheduling an examination appointment is as follows:
calling an existing appointment via an input screen of a user interface at a workstation 104 by clinic personnel 105,
rebooking of the appointment and/or the rescheduling of the corresponding examination and/or the selection of a different examination device and/or the scheduling of a different time for the underlying examination, possibly with the assistance of a user 108 of an examination workstation 107 with an examination computer 106,
booking of the changed appointment in the clinic server unit 103,
entry of an appointment via an input screen of a user interface at a workstation 104 by clinic personnel 105 at reception,
booking of the appointment via the clinic server unit 103,
initiation of an optional notification by a web service via the user interface,
selection and/or entry of further optional information for the user 101, and
forwarding of the appointment and the optional additional information by the web service to the patient device 102.

A possible sequence for an appointment request for an examination appointment is as follows:
the entry of a desired examination appointment and/or a desired examination by a user 101 via the patient device 102,
the transmission of the data to the clinic server unit 103 via the patient device 102,
updating of the user interface by web service, and
entry of the appointment request for an examination appointment at a workstation 104 of the clinic personnel 105.

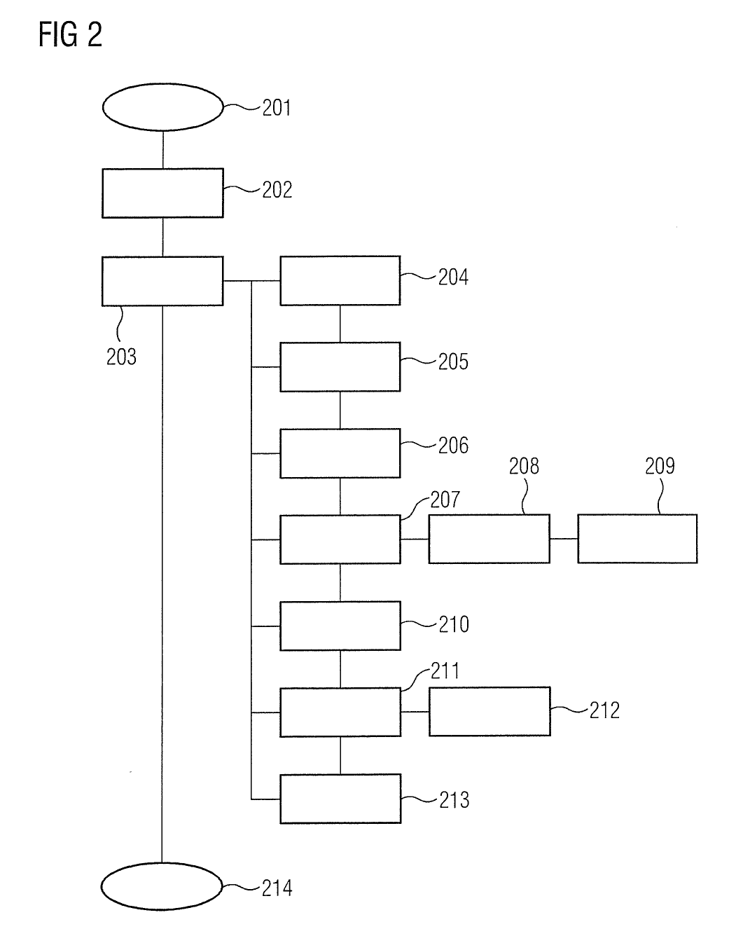

FIG. 2 is a flowchart of an embodiment of the inventive method. The method includes the method steps 201 to 214, with parts of the description including the corresponding reference characters introduced in relation to the other figure also being used in the description of the method steps 201 to 214.

Method step 201 characterizes the start of a method for controlling medical examinations by means of a patient communication system 109.

In method step 202 a connection is established between a patient device 102 and a clinic server unit 103, serving to exchange data between patient device 102 and clinic server unit 103 via a network, for example an internet or an intranet, with authentication preferably taking place by the use of a user ID and a password. The connection can also be established with the use of a framework, for example Active Server Pages .NET (ASP.NET).

During a method step 203 examination information is exchanged between the patient device 102 and the clinic server unit 103, in order to facilitate the scheduling and control of medical examinations and to allow an exchange of data between the patient device 102 and the clinic server unit 103.

Method step 204, an optional step after method step 203, describes a retrieval of examination information from the clinic server unit 103 via the patient device 102. A retrieval of examination information here also includes downloading the examination information. This means that the examination information is directly available on the patient device 102 and in most circumstances does not have to be downloaded again from the clinic server unit 103. The retrieval of examination information itself can also take place by a trigger, for example by a push service, in other words an information flow is controlled by the transmitter, in this instance by the clinic server unit 103.

Method step 205, also an optional step after method step 203, describes a retrieval of a calendar entry. If the examination information also includes an examination appointment, to which the patient is to be invited, it is also ensured, by a preferably automatic retrieval of the associated calendar entry, that the user does not forget the corresponding appointment. The retrieval of the calendar entry preferably also comprises the setting of a reminder function on the patient device, so the user can be notified of the examination appointment in advance.

Method step 206, also an optional step after method step 203, describes a retrieval of patient information by means of the patient device 102. This allows the user to be informed specifically about an examination, enabling him/her to access said information in a simple manner after an examination appointment.

In method step 207, an optional step after method step 203, a postponement request is transmitted to the clinic server unit 103 via the patient device 102. If an examination appointment to which a patient is to be invited is an appointment the patient cannot keep, the transmission of the postponement request informs clinic personnel and/or the clinic server unit 103 of the desire for a different appointment.

Method step 208, an optional step after method step 207, describes a new retrieval of the examination information by means of the patient device 102. Retrieval can again take place via a trigger, for example a push service. Retrieval can also include an automatic appointment search, in other words after receipt of the postponement request the clinic server unit 103 searches automatically for a free appointment for example and submits this as a suggestion. However retrieval can also comprise a manual appointment search, in other words a free appointment has to be confirmed beforehand for example by clinic personnel or a clinic user interface.

Method step 209, an optional step after method step 208, describes a new retrieval of a calendar entry. A calendar of a user 101 can thus be kept updated in respect of an examination appointment. Retrieval of the calendar entry can also include, for example, an updating of the existing calendar entry. Retrieval of the calendar entry also preferably includes the setting of a reminder function on the patient device 102, so that the user 101 can be notified of the examination appointment in advance.

Method step 210, an optional step after method step 203, describes an exchange of examination information that takes place automatically and/or by a trigger. An automatic exchange ensures that any changes are updated, for example at predetermined time intervals; an exchange by a trigger, for example a push service, ensures continuous updating of any changes.

During a method step 211, which is optional after method step 203, an examination request is transmitted. The autonomous transmission of an examination request for example allows a user 101 to register for an examination him/herself or make an appointment request.

Method step 212, an optional step after method step 211, describes a new retrieval of examination information via the patient device 102 after the examination request has been transmitted. The new retrieval keeps the examination information completely up to date. Retrieval can also include an automatic appointment search, in other words after receipt of the new examination request the clinic server unit 103 automatically searches for a free appointment for example and submits this as a suggestion. Retrieval can also include a manual appointment search, in other words a free appointment has to be confirmed beforehand for example by clinic personnel or a clinic user interface. Retrieval itself can again take place automatically and/or by a trigger, for example a push service.

Method step 213, an optional step after method step 203, describes the transmission of query information to the clinic server unit 103 via the patient device 102. Query information here refers for example to contact information such as a telephone number, at which a user 101 can be contacted for any queries or at which some other message can be left for the user 101. This message can also be displayed on the patient device 102.

Method step 214 characterizes the end of the method for controlling medical examinations via a patient communication system 109.

To summarize, the invention relates to a method for controlling medical examinations by means of a patient communication system that includes connecting a patient device to a clinic server unit, and exchanging examination information between the patient device and the clinic server unit.

In an embodiment the exchange of examination information includes a retrieval of examination information from the clinic server unit via the patient device, a retrieval of a calendar entry, and a retrieval of patient information.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for controlling medical examinations by means of a patient communication system, comprising:
connecting a patient device to a clinic server unit; and
exchanging examination information between the patient device and the clinic server unit.

2. The method as claimed in claim 1, wherein the exchange of examination information comprises retrieval of examination information from the clinic server unit by the patient device.

3. The method as claimed in claim 1, wherein the exchange of examination information comprises retrieval of a calendar entry.

4. The method as claimed in claim 1, wherein the exchange of examination information comprises a retrieval of patient information by the patient device.

5. The method as claimed in claim 1, wherein the exchange of examination information comprises the transmission of a postponement request to the clinic server unit by the patient device.

6. The method as claimed in claim 5, wherein the examination information is retrieved again by the patient device after the postponement request has been transmitted.

7. The method as claimed in claim 6, wherein the new retrieval of the examination information comprises a new retrieval of a calendar entry.

8. The method as claimed in claim 1, wherein the exchange of examination information takes place automatically and/or by a trigger.

9. The method as claimed in claim 1, wherein the exchange of examination information comprises the transmission of an examination request.

10. The method as claimed in claim 9, wherein the examination information is retrieved again by means of the patient device after the postponement request has been transmitted.

11. The method as claimed in claim 1, wherein the exchange of examination information comprises transmission of query information to the clinic server unit by the patient device.

12. A patient communication system for controlling medical examinations, comprising:
a patient device in communication with a clinic server unit;
the clinic server unit being configured to manage communication data; and
the patient device and the clinic server unit being configured to exchange data therebetween.

13. A non-transitory, computer-readable data storage medium encoded with programming instructions, said storage medium being loaded into a computer system that is distributed within a patient device and a clinic server unit, said programming instructions causing said computer device to:
place said patient device and said clinic server unit in communication with each other; and
cause said patient device and said clinic server unit to exchange examination information between said patient device and said clinic server unit.
